(19) United States
(12) Patent Application Publication
(10) Pub. No.: US 2022/0184990 A1
(43) Pub. Date: Jun. 16, 2022

(54) COLOUR IMAGE FORMED FROM A HOLOGRAM

(71) Applicant: IDEMIA FRANCE, COURBEVOIE (FR)

(72) Inventors: Benoît BERTHE, COURBEVOIE (FR); Christophe DURIEZ, COURBEVOIE (FR)

(21) Appl. No.: 17/432,178

(22) PCT Filed: Feb. 13, 2020
(86) PCT No.: PCT/FR2020/050262

§ 371 Date: Aug. 19, 2021

(30) Foreign Application Priority Data
Feb. 28, 2019 (FR) 19 02066

(51) Int. Cl. B42D 25/328; B42D 25/324; B42D 25/23; B42D 25/351; B42D 25/435

(52) U.S. Cl. CPC B42D 25/328; B42D 25/324; B42D 25/435; B42D 25/351; B42D 25/23

(57) ABSTRACT

A color image is disclosed. The color image comprises: a first layer including a holographic structure forming an arrangement of pixels each including sub-pixels of distinct colors; and color modulation means configured to select the color of the pixels by modifying the colorimetric contribution of the sub-pixels relative to each other in the pixels so as to reveal a customized color image. The color modulation means can comprise: regions of the holographic structure, called destroyed regions, which are locally destroyed by laser; masking means positioned facing the arrangement of pixels to locally mask all or part of the sub-pixels; or amplification means positioned facing the arrangement of pixels to locally amplify the lightness of all or part of the sub-pixels.

### TECHNICAL FIELD

The invention relates to a technique of forming color images and more particularly to a document including a holographic structure forming an arrangement of pixels from which a color image is formed.

### PRIOR ART

The identity market today requires increasingly secure identity documents (also called identity documents). These documents must be easily authenticable and difficult to counterfeit (if possible tamper-proof). This market concerns a wide variety of documents, such as identity cards, passports, access badges, driving licenses, etc., which can be presented in different formats (cards, booklets, etc.).

Various printing techniques have been developed over time to achieve color printings. The production particularly of identity documents such as those mentioned above requires the production of the color images in a secure manner in order to limit the risks of falsification by malicious individuals. The manufacture of such documents, particularly in the identity image of the bearer, needs to be sufficiently complex to make the reproduction or falsification by an unauthorized individual difficult.

Thus, a known solution consists in printing on a medium a matrix of pixels composed of color sub-pixels and forming grayscales by laser carbonization in a laserable layer located facing the matrix of pixels, so as to reveal a customized color image which is difficult to falsify or reproduce. Exemplary embodiments of this technique are described for example in documents EP 2 580 065 B1 (dated Aug. 6, 2014) and EP 2 681 053 B1 (dated Apr. 8, 2015).

Although this known technique offers good results, improvements are still possible in terms in particular of the quality of the visual rendering of the thus formed image. From this image forming technique, it is indeed difficult to achieve high levels of color saturation. In other words, the color gamut (ability to reproduce a range of colors) of this known technique can be limited, which may be problematic in some use cases. This results in particular from the fact that the color sub-pixels are formed by a conventional printing method, by offset-type printing for example, which does not allow forming sufficiently rectilinear and continuous lines of sub-pixels, which generates inhomogeneities during the printing of the sub-pixels (interruptions in the lines of pixels, irregular contours, etc.) and a degraded colorimetric rendering.

The current printing techniques further offer a limited positioning accuracy due to the accuracy in the printing machines, which also reduces the quality of the final image due to mispositioning of the pixels and sub-pixels relative to each other (problems of overlapping of the sub-pixels, misalignments . . . ) or due to the presence of a tolerance interval devoid of printing between the sub-pixels.

FIG. 1 represents an example of printing 2 by pixel offset 4 taking the form of lines 6 of sub-pixels of distinct colors. As represented, the contours of each line 6 of sub-pixels show irregularities. A tolerance must be taken into account for the positioning of these lines due to positioning inaccuracies during the printing.

As illustrated in FIG. 1, to compensate for these inhomogeneities and malpositioning of the sub-pixels of each pixel (and thus avoid the possible overlaps of neighboring sub-pixels and the degradation of the desired colors), it is possible to print the sub-pixels so as to keep a white area 8 between each of them. However, this technique of adding white areas has a drawback in that it limits the level of saturation that can be obtained for a given color, which prevents obtaining a satisfactory color gamut.

There is now a need to securely form customized color images, in particular in documents such as identity documents or the like. There is particularly a need to allow flexible and secure customization of color images, so that the thus produced image is difficult to falsify or reproduce and can be easily authenticated.

Furthermore, no solution capable of offering an appropriate level of security and flexibility today allows obtaining a good level of brightness of the image as well as a sufficient color gamut, particularly to obtain the shades of color necessary for the formation of some high-quality color images, for example when image areas need to have a highly saturated level in a given color.

### DISCLOSURE OF THE INVENTION

To this end, the invention concerns a secure document comprising:
a first layer including a holographic structure forming an arrangement of pixels each including a plurality of sub-pixels of distinct colors; and
color modulation means configured to select the color of the pixels by modifying the colorimetric contribution of the sub-pixels relative to each other in part at least of the pixels so as to reveal a customized color image from the arrangement of pixels combined with said modulation means, the color modulation means comprising at least one among:
   regions of the holographic structure, called destroyed regions, which are locally destroyed by laser;
   masking means positioned facing the arrangement of pixels to locally mask all or part of the sub-pixels; and
   amplification means positioned facing the arrangement of pixels to locally amplify the brightness of all or part of the sub-pixels.

The invention advantageously allows creating color shades so as to form a secure color image by the interaction between the color modulation means and the arrangement of pixels formed by the holographic layer. The color image is therefore formed by the combination of the color modulation means and of the arrangement of pixels located oppositely. Without the addition of the color modulation means to orient or judiciously select the passage of the incident light, the pixels only form a blank arrangement insofar as this assembly is devoid of the information characterizing the color image. It is the color modulation means that are configured, depending on the chosen arrangement of sub-pixels, to customize the visual appearance of the pixels and thus reveal the final color image.

The present invention allows producing color images with a good image quality while being secure and therefore resistant to falsifications and fraudulent reproductions.

According to one particular embodiment, each sub-pixel in the arrangement of pixels is formed by a respective holographic grating configured to generate by diffraction a corresponding color of said sub-pixel.

According to one particular embodiment, each pixel of said arrangement of pixels forms an identical pattern of color sub-pixels.

According to one particular embodiment, each pixel of said arrangement of pixels is configured such that each sub-pixel has a unique color in said pixel.

According to one particular embodiment, the arrangement of pixels is configured such that the sub-pixels are evenly distributed on or in a substrate.

According to one particular embodiment, the arrangement of pixels forms contiguous lines of sub-pixels.

According to one particular embodiment, said regions destroyed in the holographic structure correspond to areas destroyed by laser ablation of the holographic gratings corresponding to all or part of the sub-pixels in the arrangement of pixels.

According to one particular embodiment, said destroyed regions comprise sub-pixels whose corresponding holographic grating is partially destroyed by laser micro-ablation.

According to one particular embodiment, said masking means forming part of the color modulation means comprise at least one among:
ink patterns printed facing the arrangement of pixels to locally mask all or part of the sub-pixels; and
laser points of different grayscales formed in a layer, called second layer, so as to be positioned facing the arrangement of pixels to locally mask all or part of the sub-pixels.

According to one particular embodiment, said amplification means forming part of the color modulation means comprise at least one among:
an array of lenses disposed facing the arrangement of pixels so as to generate the customized color image by focusing or divergence of an incident light through the lenses on at least part of the sub-pixels; and
an optical amplification device comprising a transparent laserable layer, called third layer, and a transparent separating layer disposed between the first layer and the third layer, said third layer comprising areas locally opacified with laser, facing the first layer so as to cause an amplification of the brightness of sub-pixels in said arrangement of pixels in regions corresponding to said opacified areas.

According to one particular embodiment, each lens of the array of lenses is positioned, relative to an associated pixel located oppositely, to focus or diverge an incident light on at least one of the sub-pixels of said associated pixel so as to modify the contribution of the respective colors of the sub-pixels of the associated pixel, in a region of the customized color image generated through said lens, relative to the pattern intrinsically formed by the associated pixel independently of said lens.

According to one particular embodiment, the document further comprises a transparent laserable layer, called fourth layer, facing the first layer, said fourth layer being at least partially carbonized by laser radiation so as to comprise locally opacified regions facing sub-pixels of the arrangement of pixels to produce grayscales in the customized color image.

According to one particular embodiment, the first layer comprises:
a first sub-layer of varnish forming the reliefs of a holographic grating; and
a second sub-layer deposited on the reliefs of the first sub-layer, said second sub-layer having a refractive index greater than that of the first sub-layer.

The invention also relates to a corresponding manufacturing method. More particularly, the invention relates to a method for manufacturing a document, comprising the following steps:
creating in a first layer a holographic structure forming an arrangement of pixels each including a plurality of sub-pixels of distinct colors;
forming color modulation means to select the color of the pixels by modifying the colorimetric contribution of the sub-pixels relative to each other in part at least of the pixels so as to reveal a customized color image from the arrangement of pixels combined with said color modulation means, the color modulation means comprising at least one among:
   regions of the holographic structure, called destroyed regions, which are locally destroyed over all or part of the sub-pixels by a single first laser radiation;
   masking means positioned facing the arrangement of pixels to locally mask all or part of the sub-pixels; and
   amplification means positioned facing the arrangement of pixels to locally amplify the brightness of all or part of the sub-pixels.

According to one particular embodiment, said formation of the color modulation means comprises at least one among:
local destruction, by means of a single first laser radiation (at a single wavelength), by laser ablation, of regions of the holographic structure to eliminate all or part of the sub-pixels in the arrangement of pixels;
printing of ink patterns facing the first layer to locally mask all or part of the sub-pixels in the arrangement of pixels;
formation, by means of a single second laser radiation (at a single wavelength), of an array of lenses disposed facing the arrangement of pixels so as to generate the customized color image by focusing or divergence of an incident light through the lenses on at least part of the sub-pixels of the arrangement of pixels; and
formation of an optical amplification device comprising a transparent laserable layer, called third layer, and a transparent separating layer disposed between the first layer and the third layer, said third layer comprising areas locally opacified by means of a single third laser radiation (at a single wavelength), facing the first layer so as to cause an amplification of the brightness of sub-pixels in said arrangement of pixels in regions corresponding to said opacified areas.

### BRIEF DESCRIPTION OF THE DRAWINGS

FIG. 1, already described above, schematically represents the printing of lines of color sub-pixels on a medium.

FIG. 2 schematically represents a color image according to one particular embodiment of the invention;

FIG. 3 schematically represents a secure document according to one particular embodiment of the invention;

FIG. 4 schematically represents a holographic layer of a secure image according to one particular embodiment of the invention;

FIG. 5 schematically represents the reliefs of a holographic layer according to one particular embodiment of the invention;

FIGS. 6A and 6B schematically represent a pixel formed by a region of a holographic structure, according to one particular embodiment of the invention;

FIGS. 7A, 7B and 7C schematically represent an arrangement of pixels and sub-pixels, according to particular embodiments of the invention;

FIG. 8 schematically represents a color image according to one particular embodiment of the invention;

FIG. 9 schematically illustrates the partial destruction of sub-pixels, according to one particular embodiment of the invention;

FIG. 10 schematically represents a color image according to one particular embodiment of the invention;

FIG. 11 schematically represents a color image according to one particular embodiment of the invention;

FIG. 12 schematically represents a color image according to one particular embodiment of the invention;

FIG. 13 schematically represents a color image according to one particular embodiment of the invention; and

FIG. 14 schematically represents a manufacturing method according to one particular embodiment of the invention.

### DESCRIPTION OF THE EMBODIMENTS

As indicated above, the invention generally relates to the formation of a color image and concerns particularly a secure document including such an image.

The invention proposes to form a color image in a secure manner from a holographic layer including a hologram forming an arrangement of pixels, these pixels themselves including a plurality of color sub-pixels, and from color modulation means which are configured to select the color of the pixels in the holographic layer by modifying the relative colorimetric contribution of the sub-pixels relative to each other in part at least of the pixels. As described in more detail below, various embodiments are possible. Particularly, the aforementioned color modulation means can take various forms as explained below with reference to the figures.

The color modulation means alter the colorimetric contribution (or weight) of sub-pixels relative to the neighboring sub-pixels in the corresponding pixels, so as to reveal a customized color image from the combination of the arrangement of pixels and said modulation means.

The invention also concerns a method for forming such a color image.

Other aspects and advantages of the present invention will emerge from the exemplary embodiments described below with reference to the drawings mentioned above.

In the remainder of this document, examples of implementations of the invention are described in the case of a document including a color image according to the principle of the invention. This document can be any document, called secure document, of the booklet or card type or the like. The invention finds particular applications in the formation of identity images in identity documents such as: identity cards, debit cards, passports, driving licenses, secure entry badges etc. The invention also applies to security documents (banknotes, notarized documents, official certificates . . . ) including at least one color image.

In general, the image according to the invention can be formed on any suitable medium.

Likewise, the exemplary embodiments described below aim to form an identity image. It is however understood that the considered color image can be any color image. This may for example be an image representing the portrait of the holder of the concerned document, other implementations being however possible.

Unless otherwise indicated, the elements common or similar to several figures bear the same reference signs and have identical or similar characteristics, so that these common elements are generally not described again for the sake of simplicity.

FIG. 2 schematically represents a color image IG in accordance with one particular embodiment of the invention.

As illustrated in this figure, the color image IG comprises a holographic layer (also called first layer) 12 coupled to, or including, color modulation means 10. The holographic layer 12 includes a holographic structure forming an arrangement 29 of pixels 30, each of the pixels including a plurality of sub-pixels 32 of distinct colors.

As described below, the holographic layer 12 intrinsically forms an arrangement 29 of pixels which is blank, in the sense that the pixels 30 do not include the information defining the pattern of the image IG desired to be formed. It is by combining this arrangement 29 of pixels with the color modulation means 10 that a pattern of a customized color image is revealed. To do so, the color modulation means 10 are configured to select the color of the pixels 30 by modifying the colorimetric contribution of the sub-pixels 32 relative to each other in part at least of the pixels 30 formed by the holographic layer 12, so as to reveal a customized color image IG from the arrangement 29 of pixels combined with the color modulation means 10.

In other words, the color modulation means 10 are configured to cause a selective passage (or modified, by masking, amplification or the like) of light from the holographic layer 12 towards an observation point external to the image IG. These modulation means 10 thus generate color shades in the pixels 30 by modifying the contribution of some sub-pixels in the visual rendering of the final image IG.

The color modulation means 10 allow particularly modulating the passage of light so that, for part at least of the pixels 30, at least one sub-pixel has an increased or decreased contribution compared to that of at least one other sub-pixel neighboring the concerned pixel.

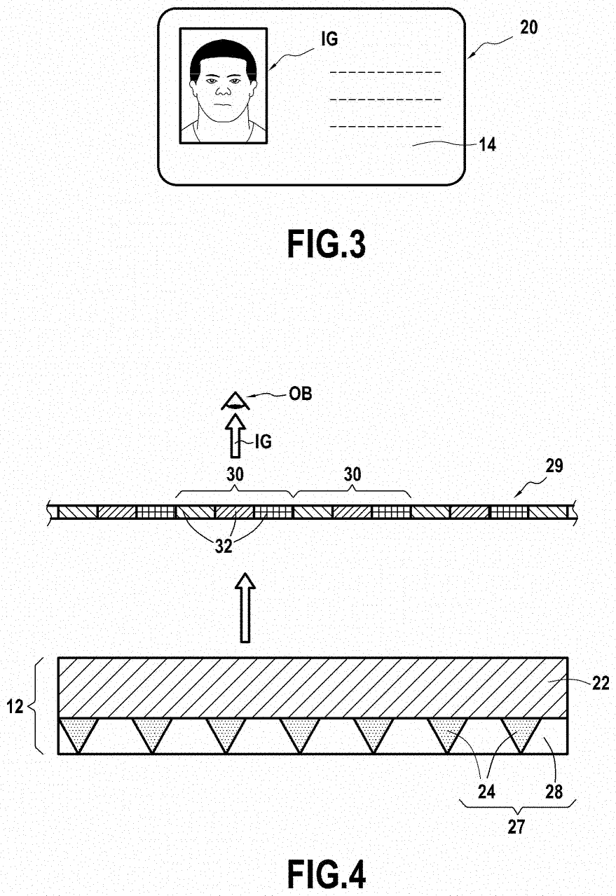

As already indicated, the color image IG can be formed on any medium. As represented in FIG. 3, a secure document 20 including a document body 14 in or on which a secure image IG is formed as described above with reference to FIG. 2 will be considered hereinafter.

In the following exemplary embodiments, it is assumed that the secure document 20 is an identity document, for example in the form of a card, such as an identity card, an identification badge or the like. In these examples, the image IG is a color image whose pattern corresponds to the portrait of the document holder. As already indicated, however, other examples are possible.

In general, the holographic layer 12 has a holographic structure so as to produce the arrangement 29 of pixels in the form of a hologram by diffraction, refraction, and/or reflection of an incident light. The principle of the hologram is well known to those skilled in the art. Some elements are recalled below for reference. Exemplary embodiments of holographic structures are described for example in document EP 2 567 270 B1.

FIG. 4 represents, according to one particular embodiment, the holographic layer 12 of the color image IG mentioned above. To facilitate the description of the invention, the holographic layer 14 is represented here in its inherent form that is to say without the presence of the color modulation means 10 (which will be described later).

The holographic layer 12 includes a layer (or sub-layer) 22 as well as reliefs (or relief structures) 24, containing three-dimensional information, which are formed from the layer 22 serving as a medium. These reliefs 24 form protruding portions (also called “mountains”) separated by recesses (also called “valleys”).

The holographic layer 22 further includes a layer (or sub-layer) 28, called high-refractive index layer, which has a refractive index n2 greater than the refractive index n1 of the reliefs 24 (it is assumed here that the reliefs 24 form an integral part of the layer 22 serving as a medium, so that the reliefs 24 and the layer 22 have the same refractive index n1). This layer 28, which can be a metallic and/or dielectric layer, covers the reliefs 24 of the holographic layer 12. As understood by those skilled in the art, the reliefs 24, in combination with the layer 28, form a holographic structure 27 which produces a hologram (a holographic effect).

The reliefs 24 of the holographic structure 27 can be formed for example by embossing of a layer of stamping varnish (included in the layer 22 in this example) in a known manner for making diffractive structures. The stamped surface of the reliefs 24 thus is in form of a periodic array whose depth and period can be respectively on the order of a hundred to a few hundred nanometers for example. This stamped surface is coated with the layer 28, for example by means of vacuum deposition of a transparent dielectric material (with a high optical index) or/and of a metallic material. The holographic effect results from the association of the reliefs 24 and of the layer 28 forming the holographic structure 27.

The holographic layer 12 may optionally comprise other sub-layers (not represented) necessary to maintain the optical characteristics of the hologram and/or allowing ensuring a mechanical and chemical resistance of the assembly.

The high refractive index layer 28 (FIG. 4) can be formed from at least one among the following materials: aluminum, silver, copper, zinc sulfide, titanium oxide . . . .

In the exemplary embodiments described in this document, the holographic layer 12 is transparent, so that the holographic effect revealing the color image IG is visible by diffraction, reflection and refraction. However, other arrangements can be envisaged in which the holographic layer 12 is opaque so that the color image IG is only visible by reflection of an incident light on the holographic structure 27.

The holographic structure 12 is made by any suitable method known to those skilled in the art.

The reliefs 24 have a refractive index denoted n1, on the order of 1.56 at a wavelength λ=656 nm for example.

In the example considered here (FIG. 4), the layer 22 is a transparent varnish layer. The holographic structure 27 is coated with a thin layer 28, for example made of aluminum or zinc sulfide, having a high refractive index n2 (compared to n1), for example of 2.346 at a wavelength λ=660 nm for zinc sulfide. The thin layer 28 has, for example, a thickness between 30 and 200 nm.

The layer 22 can be a thermoformable layer thus allowing the reliefs 24 of the holographic structure 27 to be formed by embossing on the layer 22 serving as a medium. As a variant, the reliefs 24 of the holographic structure 27 can be made using an ultraviolet (UV) crosslinking technique. As these manufacturing techniques are known to those skilled in the art, they are not described in more detail for the sake of simplicity.

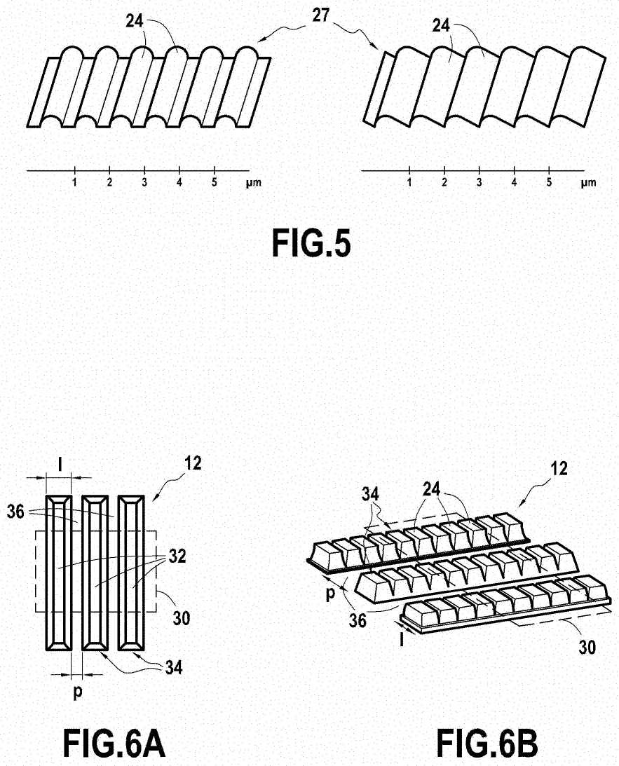

FIG. 5 represents examples of reliefs 24 of a holographic structure 27, including protruding portions and recesses.

Still referring to FIG. 4, the holographic layer 12 can be encapsulated or assembled with various other layers. Moreover, as already indicated, the holographic layer 12 forms an arrangement 29 of pixels 30. Each pixel 30 comprises a plurality of color sub-pixels 32, namely 3 sub-pixels 32 in the example considered here.

An observer OB can thus visualize according to a particular direction of observation the arrangement 29 of pixels from a light refracted, reflected and/or diffracted from the holographic structure 27 of the holographic layer 12.

As illustrated below, the arrangement 29 of pixels can take various forms.

FIGS. 6A and 6B represent, according to one particular embodiment, a pixel 30 formed by a region of the holographic structure 27 present in the holographic layer 12. More particularly, it is considered here that the reliefs 24 of the holographic structure 27 (FIG. 4) form parallel lines 34 of sub-pixels, other implementations being however possible. For each pixel 30, its constituent sub-pixels 32 are thus formed by a portion of a respective line 30, this portion constituting a respective holographic grating (or holographic grating portion) configured to generate by diffraction and/or reflection a corresponding color of said sub-pixel.

In the example envisaged here, the pixels 30 thus include 3 sub-pixels of distinct colors, other examples being however possible. It is assumed that each sub-pixel 32 is monochromatic. Each holographic grating is configured to generate a color in each sub-pixel 32 corresponding to a predetermined observation angle, this color being modified at a different observation angle. It is for example assumed that the sub-pixels 32 of each pixel 30 respectively have a distinct fundamental color (for example green/red/blue or cyan/yellow/magenta) at a predetermined observation angle.

As represented in FIGS. 6A and 6B, the holographic gratings corresponding to the three lines 34, which form the sub-pixels 32 of the same pixel 30, have particular geometric specifications so as to generate a desired distinct color. Particularly, the holographic gratings forming the 3 sub-pixels 32 in this example have a width denoted l and a pitch between each holographic grating denoted p.

Thus, in the example considered where each pixel 30 is composed of 4 sub-pixels 32, the theoretical maximum saturation capacity S in one of the colors of the sub-pixels in a same pixel can be stated in the following way:

$$S = \frac{25}{100} \times \frac{l}{l + p} \qquad [ Math . 1 ]$$

By way of example, it can be considered that l=60 μm and p=10 μm which leads to a theoretical maximum saturation capacity S=0.21.

It is possible to form the holographic gratings forming the sub-pixels 32 so that the pitch p tends towards zero, which allows increasing the theoretical maximum saturation capacity in a color by one sub-pixel (S then tending towards 0.25).

According to one particular example, the pitch is set to p=0, which allows reaching a theoretical maximum saturation capacity S equal to 0.25. In this case, the lines 34 of sub-pixels as represented in FIGS. 6A and 6B are contiguous (no space or white area being present between the lines of sub-pixels).

The invention thus allows forming lines of sub-pixels which are contiguous, that is to say adjacent to each other without it being necessary to leave separating white areas between each line, or possibly by keeping separating white areas but of limited dimension between the lines of sub-pixels (with a small pitch p). As will appear more clearly in the light of the following exemplary embodiments, this particular configuration of the holographic gratings allows significantly improving the quality of the final image IG (better color saturation). This is possible in particular because the formation of holographic structures allows achieving better accuracy in the positioning of the sub-pixels and better homogeneity than by conventional printing of the sub-pixels (by offset or the like).

As already indicated, the arrangement 29 of pixels 30 formed by the holographic layer 12 (FIG. 2) can take various forms. Exemplary embodiments are described below.

In general, the arrangement 29 of pixels can be configured so that the sub-pixels 32 are evenly distributed in the holographic layer 12. The sub-pixels 32 can for example form parallel lines of sub-pixels or another hexagon-shaped (Bayer type) array, other examples being possible.

The sub-pixels 32 can for example form an orthogonal matrix.

The pixels 30 can be evenly distributed in the arrangement 29 so that the same pattern of sub-pixels 32 is periodically repeated in the holographic layer 12.

Furthermore, each pixel 30 of the arrangement 29 of pixels can be configured so that each sub-pixel 32 has a unique color in said considered pixel. According to one particular example, each pixel 32 in the arrangement 29 of pixels forms an identical pattern of color sub-pixels.

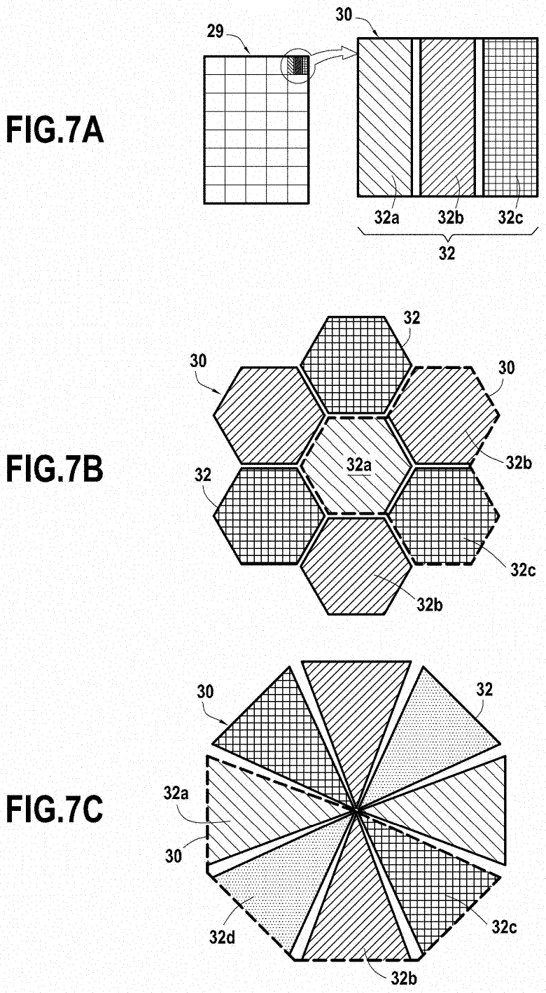

Particular examples of arrangements (or tiling) 29 of pixels that can be implemented in the secure document 20 (FIG. 3) are now described with reference to FIGS. 7A, 7B and 7C. It should be noted that these implementations are presented only by way of non-limiting examples, many variants being possible in terms in particular of arrangement and shape of the pixels and sub-pixels, as well as colors assigned to these sub-pixels.

According to a first example represented in FIG. 7A, the pixels 30 of the arrangement 29 of pixels are rectangular (or square) and comprise 3 sub-pixels 32a, 32b and 32c (collectively denoted 32) of distinct colors. As already described with reference to FIGS. 6A-6B, the sub-pixels 32 may be each formed by a portion of a line 34 of sub-pixels. In this example, the tiling 29 thus forms a matrix of rows and columns of pixels 30, orthogonal to each other.

FIG. 7B is a top view representing another example of regular tiling in which each pixel 30 is composed of 3 sub-pixels 32, denoted 32a to 32c, each of a distinct color. The sub-pixels 32 are here hexagonal.

FIG. 7C is a top view representing another example of regular tiling in which each pixel 30 is composed of 4 sub-pixels 32, denoted 32a to 32d, each of a distinct color. The sub-pixels 32 are here triangular.

For each of the considered arrangements of pixels, it is possible to adapt the shape and the dimensions of each pixel 30 and also the dimensions of the present separating white areas, where appropriate, between the sub-pixels, so as to achieve the desired maximum color saturation level and the desired brightness level.

As already described, the color modulation means 10 comprised in the image IG (FIGS. 2-3) can have different forms. In general, the color modulation means 10 can comprise at least one among:
regions of the holographic structure 12, called destroyed regions, which are locally destroyed by laser;
masking means positioned facing the arrangement 29 of pixels 30 to locally mask all or part of the sub-pixels 32; and
amplification means positioned facing the arrangement 29 of pixels 30 to locally amplify the brightness of all or part of the sub-pixels 32.

Examples of particular implementation of the secure document 20, comprising a color image IG as described previously with reference to FIGS. 2-7C, are described below. In these examples, the image IG (more specifically denoted IG1 to IG5, respectively) thus comprises a holographic layer 12 and color modulation means 10 as already described in general.

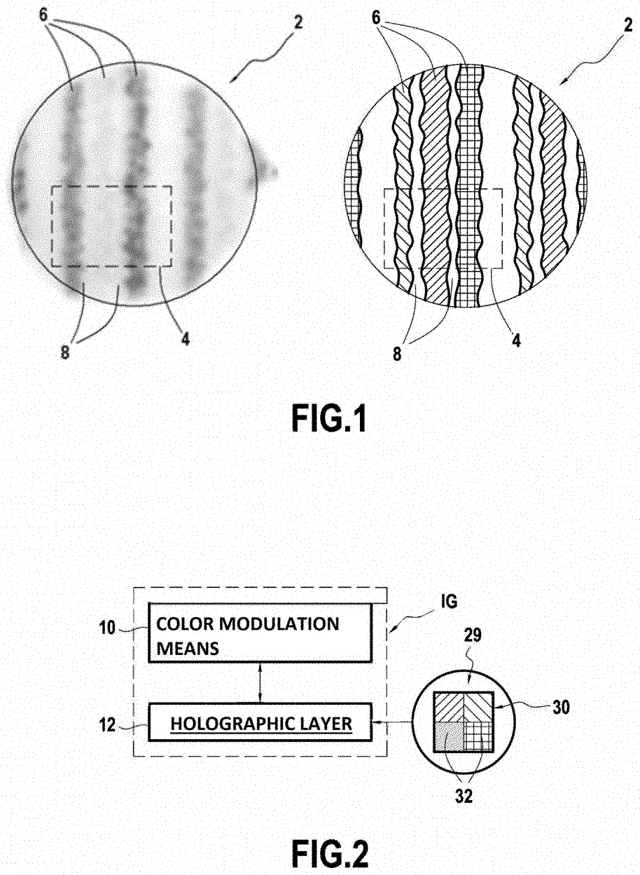

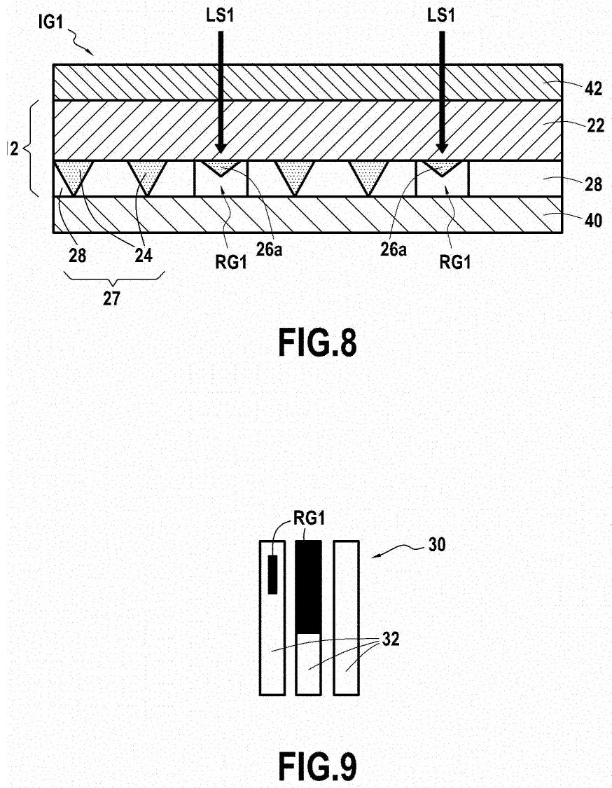

More particularly, a first particular embodiment of the secure document 2 (FIG. 1) is described with reference to FIGS. 8 and 9. In this example, the holographic layer 12 is interposed between transparent layers 40 and 42. In the examples considered here, these two layers are made of polycarbonate, or any other suitable material for covering the holographic layer 12.

The holographic layer 12 includes regions RG1 of the holographic structure 27, called destroyed regions, which are locally destroyed by laser. This selective destruction of the holographic structure 27 leads to a partial or total destruction of one or a plurality of sub-pixels 32 in part at least of the pixels 30, which causes a modification of the holographic effect in the concerned regions. Thus, the holographic effect is eliminated, or decreased, in the destroyed regions of the holographic structure 27, which decreases (or totally eliminates) the relative color contribution of one or a plurality of sub-pixels 32, located facing the destroyed regions RG1, relative to at least one other neighboring sub-pixel 32 of the concerned pixels 30. In other words, this selective destruction of the holographic structure 27 leads to a modification of the colorimetric weight of some sub-pixels 32, in the final color image denoted here IG1, relative to at least one other sub-pixel 32 neighboring the concerned pixels 30.

These destroyed regions RG1 thus collectively form color modulation means 10 which are configured, in combination with the holographic layer 12, to reveal the customized color image IG1 (FIGS. 2-3), as already described above.

The laser destruction causes a local elimination (or deformation) of the geometry of the holographic structure 27, and more particularly of the reliefs 24 and/or of the layer 28 covering said reliefs. These local destructions result in a modification of the behavior of light (i.e. the reflection, diffraction and/or refraction of light) in the corresponding pixels and sub-pixels.

According to one particular example, these destroyed regions RG1 in the holographic structure 27 correspond to areas destroyed by laser ablation in the holographic gratings corresponding to all or part of the sub-pixels 32 in the arrangement 29 of pixels. Thus, it is possible to perform a partial laser ablation of a sub-pixel 32, as illustrated by way of example in FIG. 9, so as to decrease the color contribution of said sub-pixel in the concerned pixel 30.

The laser ablation (FIGS. 8-9) can be performed by means of a laser radiation LS1, for example of the Nd: YAG type, having a single wavelength, for example on the order of 1,064 nm.

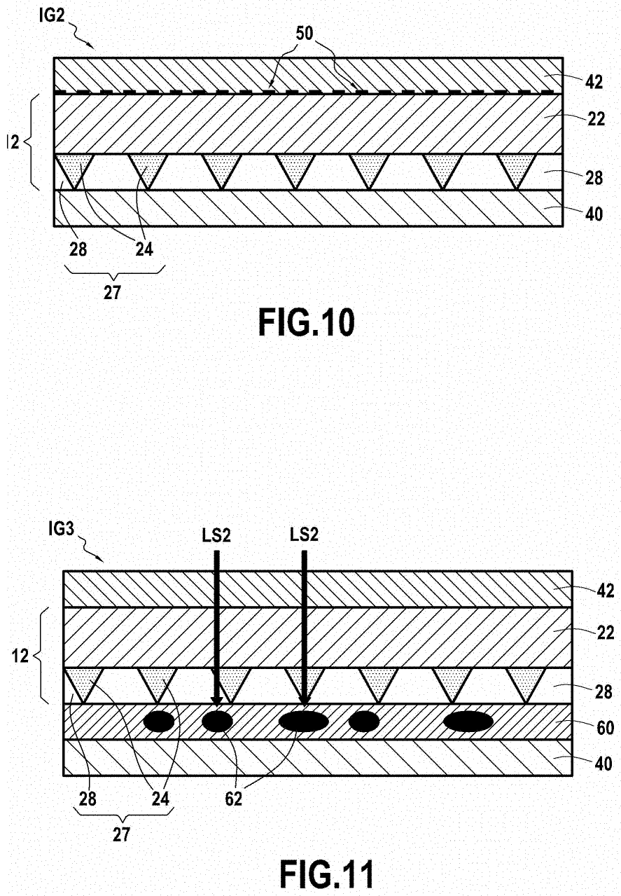

A second particular embodiment of the secure document 2 (FIG. 1) is now described with reference to FIG. 10. In this example, the holographic layer 12 previously described with reference to FIGS. 2-7C is also interposed between a layer 40 and a layer 42, as already described with reference to FIG. 9.

A pattern 50 is further printed facing the holographic structure 27, that is to say facing the arrangement 29 of pixels 30, so as to locally mask all or part of the sub-pixels 32. This pattern 50 is formed from an ink (or an equivalent material) which allows at least partially masking some regions of the holographic structure 27.

The addition of this printed pattern 50 in the overall structure allows decreasing (even totally eliminating) the relative color contribution of one or a plurality of sub-pixels 32, located facing the printed pattern 50, relative to at least one other neighboring sub-pixel 32 in the concerned pixels 30. In other words, this selective masking of the holographic structure 27 leads to a modification of the colorimetric weight of some sub-pixels 32, in the final color image denoted here IG2, relative to at least one other sub-pixel 32 neighboring the concerned pixels 30.

This printed pattern 50 thus forms color modulation means 10 which are configured, in combination with the holographic layer 12, to reveal the customized color image IG2 (FIGS. 2-3), as already described above. Insofar as this pattern 50 aims to locally mask some sub-pixels, it more particularly constitutes masking means within the meaning of the invention.

The ink used to form this printed pattern 50 can be black, white or any other color, depending on the desired masking effect, so as to modulate the color of the pixels 30 in the arrangement 29 of pixels.

It is particularly possible to perform a printing, of the inkjet type for example, so as to mask only a portion of a sub-pixel 32 (even the entire sub-pixel 32), which allows decreasing the relative color contribution of said sub-pixel 32 in the concerned pixel 30.

In the example represented in FIG. 10, the pattern 50 is printed on the upper face of the holographic layer 12, opposite the holographic structure 27. Other embodiments are however possible. It is for example possible to print the pattern 50 on another layer facing the holographic layer 12, such as for example on the layer 40, on the layer 42 or on an additional layer not represented. The printing of the pattern 50 is also possible on the lower face of the holographic layer 12.

A third particular embodiment of the secure document 2 (FIG. 1) is now described with reference to FIG. 11. In this example, the holographic layer 12 already described with reference to FIGS. 2-7C is also interposed between transparent layers 40 and 42, as already described with reference to FIG. 9.

In this example, a transparent layer 60 sensitive to the laser, called laserable layer, is also disposed at the interface between the holographic layer 12 and the layer 40. This laserable layer 60 is able to be locally opacified by means of a laser radiation LS2 in order to at least partially block the passage of light, which thus allows at least partially masking one or a plurality of sub-pixels.

As illustrated, the laserable layer 40 thus comprises areas (or volumes) 62, called opaque areas, locally opacified by a laser radiation LS2, these opaque areas being positioned facing the holographic structure 27 so as to locally mask all or part of the sub-pixels 32. More particularly, these opaque areas 62 constitute laser points, of variable shapes and opacities, which are formed by local carbonization of the laserable layer 60. By adjusting particularly the power of the laser LS2 and/or over the duration of the impact, the desired opaque areas 62 can be formed. Thus, the degree of blackening is a function of the energy applied by the laser radiation LS2.

The opaque (non-reflective) areas 60 are formed facing some sub-pixels 32 so as to produce grayscales in the final color image denoted here IG3.

The addition of these opaque areas 62 allows decreasing (even totally eliminating) the relative color contribution of one or a plurality of sub-pixels 32, located facing each other, relative to at least one other sub-pixel 32 neighboring the concerned pixels 30. In other words, this selective masking of the holographic structure 27 leads to a modification of the colorimetric weight of some sub-pixels 32, in the final color image IG1, relative to at least one other sub-pixel 32 neighboring the concerned pixels 30.

These opaque areas 62 thus collectively form color modulation means 10 which are configured, in combination with the holographic layer 12, to reveal the customized color image IG3 (FIGS. 2-3), as already described above. Insofar as these opaque areas 62 aim to locally mask some sub-pixels, they more particularly constitute masking means within the meaning of the invention.

In the example represented in FIG. 11, the laserable layer 60 is located under the holographic layer 12, on the side of the holographic structure 27. Other implementations are however possible. The laserable layer 60 can particularly be positioned above the holographic layer 12, on the opposite side to the holographic structure 27. As a variant, several laserable layers including opaque areas can be arranged above and below the holographic layer 12.

The laserable materials which can be used to form the laserable layer(s) described in this document are, by way of non-limiting examples, polycarbonates, some treated polyvinyl chlorides, treated acrylonitrile-butadiene-styrenes or treated poly-ethylene terephthalates.

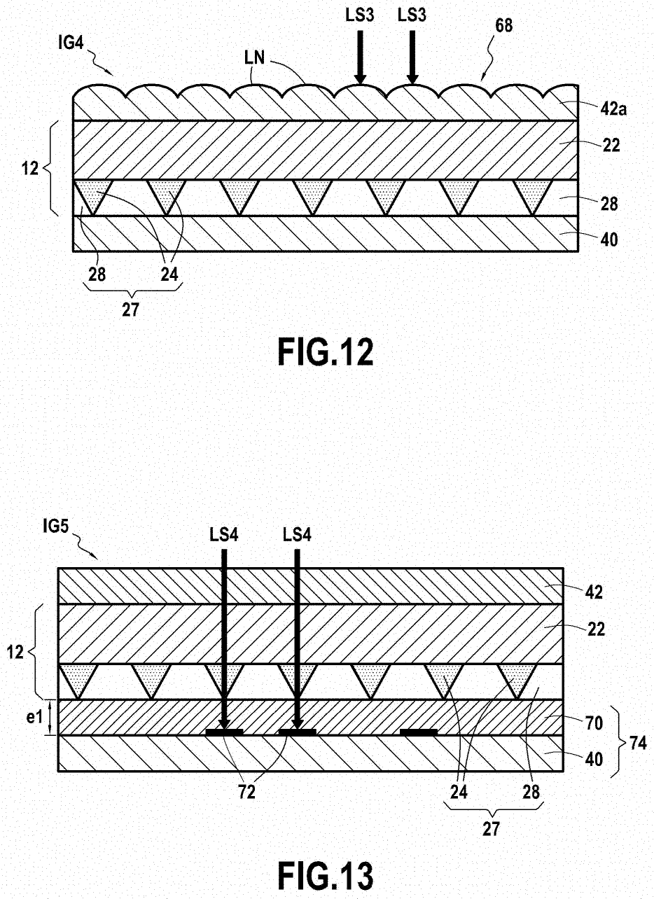

A fourth particular embodiment of the secure document 2 (FIG. 1) is now described with reference to FIG. 12. In this example, the holographic layer 12 already described with reference to FIGS. 2-7C is also interposed between transparent layers 40 and 42a. The layers 40 and 42a can be made of polycarbonate or any other suitable material.

In this example, a lenticular array 68 including a plurality of lenses LN is disposed facing the arrangement 29 of pixels formed by the holographic layer 12, so as to generate the customized color image—denoted here IG4—by focusing or divergence of incident light through the lenses LN on at least part of the sub-pixels 32.

The lenticular array 68 is formed in this example on the surface of the upper layer 42a, although other implementations are possible. The lenses LN can be formed for example by projection of a laser radiation LS3. It is for example possible to use a CO₂-type laser radiation or the like to create surface deformations defining the lenses LN of the lenticular array 68. The layer 42a is itself laminated on the holographic layer 12, or optionally on an intermediate layer located between the layer 42a and holographic layer 12.

Each lens can be positioned (or configured), relative to a pixel 30 (called associated pixel) located oppositely, to focus or diverge the incident light on at least one of the sub-pixels 32 of said associated pixel so as to modify the contribution of the respective colors of the sub-pixels of the associated pixel, in a region of the color image IG4 generated through the lens, relative to the pattern intrinsically formed by the associated pixel 30 independently of (or without) said lens.

In other words, each lens LN can be positioned (or configured), relative to an associated pixel 30 located oppositely, to focus or diverge the incident light on at least one of the sub-pixels 32 of said associated pixel so as to modify the respective relative color contribution of at least one sub-pixel of the associated pixel, in a region of the color image corresponding to said pixel, relative to the respective color contribution of the other sub-pixel(s) neighboring said associated pixel.

The lenses LN thus allow amplifying the brightness of some sub-pixels 32 and decreasing the brightness of other sub-pixels 32, which produces color shades making it possible to reveal the final color image IG4 by the interaction between the lenticular array 68 and the arrangement 29 of pixels formed by the holographic structure 27. From the same blank arrangement 29 of pixels 30, it is thus possible to adapt the configuration of the lenses LN so as to generate various color images IG4.

The lenticular array 68 thus forms color modulation means 10 which are configured, in combination with the holographic layer 12, to reveal the customized color image IG4 (FIGS. 2-3), as already described above. Insofar as this lenticular array 68 aims in particular to amplify the brightness of some sub-pixels relative to others, it more particularly constitutes amplification means within the meaning of the invention.

According to one particular example, the lenses LN (or part at least thereof) are convergent lenses configured to focus the incident light received so as to accentuate the relative color contribution of at least one sub-pixel 32 of the associated pixel (pixel located oppositely), in the corresponding region of the color image IG4 generated through said lens, relative to the respective color contribution of each other sub-pixel 32 neighboring said associated pixel 30.

According to one particular example, the lenses LN are configured to focus light on a single sub-pixel 32 of the associated pixel 30 so as to mask the color of each other sub-pixel 32 neighboring the associated pixel 30 in the corresponding region of the color image IG4 generated through said lens.

It is further possible to configure lenses LN in the lenticular array 68 so that they focus the light on sub-pixels 32 of the same color in the pixels 30 of a given region of the holographic structure 27, so that a monochrome region appears in the customized color image IG4.

As a variant, it is possible to configure lenses LN in the lenticular array 68 so that they focus the light on at least two sub-pixels 32 neighboring the associated pixel 30, thus making a hybrid color resulting from a combination of the colors of said at least two neighboring sub-pixels 32 appear in a corresponding region of the color image IG4.

According to one particular example, part at least of the divergent lenses LN are configured to diverge an incident light received by the lens so as to reduce the color contribution of at least one sub-pixel 32 of the associated pixel 30, in the corresponding region of the color image IG4 generated through said lens, relative to the respective color contribution of the other sub-pixel(s) 32 neighboring the associated pixel 30.

The arrangements above are described only by way of example, other implementations of the lenticular array 68 being possible. In the example represented in FIG. 12, the lenticular array 68 is located above the holographic layer 12. As a variant, the lenticular array 68 may be formed on a laminated layer (e.g., the layer 40) under the holographic layer 12 (on the side of the holographic structure 27).

A fifth particular embodiment of the secure document 2 (FIG. 1) is now described with reference to FIG. 13. In this example, the holographic layer 12 already described with reference to FIGS. 2-7C is also interposed between transparent layers 40 and 42 as already described above.

The color image denoted here IG5 is formed by the combination of the holographic layer 12 already described above and of an optical amplification device 74 comprising a transparent laserable layer and a transparent separating layer 70 disposed between the holographic layer 12 and the transparent laserable layer. The transparent laserable layer and the transparent separating layer 70 are located under the holographic layer 12 that is to say on the side of the holographic structure 27 formed by the reliefs 24 and the high refractive index layer 28. As explained below, the transparent separating layer 70 allows maintaining a gap noted e1 between the holographic layer 12 and the transparent laserable layer.

In the example considered here, the transparent laserable layer mentioned above is the layer 40 located under the holographic layer 12, although other arrangements are possible.

Still in this example, the laserable layer 40 comprises areas locally opacified 72 by means of laser radiation LS4, facing the holographic layer 12 so as to cause an amplification of the brightness of sub-pixels 32 in the arrangement 30 of pixels in regions of the final color image IG5 corresponding to the opacified areas 72. The technique of forming the opaque areas 72 is identical to the technique described above with reference to FIG. 11 to form the opaque areas 62. The laserable layer 40 may be identical to the laserable layer 60 described with reference to FIG. 11. Particularly, the opaque areas 72, partially or totally blocking the light, are produced by laser carbonization of some regions of the laserable layer 40.

The transparent separating layer 70 allows maintaining a gap e1 between the holographic structure 27 and the opaque areas 72. The formation of the opaque areas 72 in the laserable layer 40, at a distance from the holographic structure 27, allows generating a local amplification phenomenon of the brightness of the sub-pixels 32 located facing said opaque areas 72. To obtain this optical amplification effect, it is necessary that the thickness e1 of the transparent separating layer 70 is greater than or equal to half of the longest wavelength—denoted λₘₐₓ—in the visible spectrum. In other words, it is necessary that:

e1≥½×λₘₐₓ=375 nm [Math. 2]

where λₘₐₓ=750 nm

According to one particular example, the thickness e1 is between 0.375 μm and 100 μm (bounds included), and preferably between 0.375 μm and 5 μm (bound included).

Each opaque area 72 in the laserable layer 40 is positioned facing at least one sub-pixel 32 so as to amplify its relative colorimetric contribution in the region of the final color image IG5 relative to at least one other sub-pixel 32 neighboring the considered pixel 30.

The optical amplification device 74 thus forms color modulation means 10 which are configured, in combination with the holographic layer 12, to reveal the customized color image IG (FIGS. 2-3), as already described above. Insofar as this optical amplification device 74 aims to amplify the brightness of some sub-pixels relative to others, it more particularly constitutes amplification means within the meaning of the invention.

In general, with reference to each of the embodiments described above, it is possible to further generate contrast in the thus obtained color image IG by incorporating into the overall structure a laserable layer, if such a layer is not already present in said structure. This laserable layer can be locally carbonized with laser in an identical manner to what is described above with reference to the laserable layer 60 (FIG. 11) or to the laserable layer 40 (FIG. 13), in order to create contrast in the final color image and thus improve the quality of its visual rendering.

More particularly, the overall structure of the color image may further comprise such a transparent laserable layer facing the holographic layer 12, this laserable layer being at least partially carbonized by laser radiation so as to comprise locally opacified regions facing sub-pixels 32 of the arrangement 29 of pixels to produce grayscales in the customized color image.

In general, the invention advantageously allows creating color shades so as to form a secure color image by the interaction between the color modulation means and the arrangement of pixels formed by the holographic layer. The color image is therefore formed by the combination of the color modulation means and of the arrangement of pixels located oppositely. Without the addition of the color modulation means to orient or judiciously select the passage of the incident light, the pixels only form a blank arrangement insofar as this assembly is devoid of the information characterizing the color image. It is the color modulation means that are configured, depending on the chosen arrangement of sub-pixels, to customize the visual appearance of the pixels and thus reveal the final color image.

The present invention allows producing color images with a good image quality while being secure and therefore resistant to falsifications and fraudulent reproductions.

More particularly, the invention allows obtaining an increased image quality, namely better overall brightness of the final image (more brightness, more vivid colors) and a better color saturation capacity. In other words, the invention allows achieving a high-quality color image with an improved colorimetric gamut compared to a printed image.

The use of a holographic structure to form the arrangement of pixels is advantageous in that this technique offers high positioning accuracy of the thus formed pixels and sub-pixels. This technique allows in particular avoiding overlaps or misalignments between sub-pixels, which improves the overall visual rendering.

As already described with reference to FIGS. 6A-6B, due to the increased positioning accuracy compared to the case of a conventional printing technique, the invention allows decreasing, even eliminating, the separating white areas it would otherwise be necessary to provide between the sub-pixels (for example between the lines of sub-pixels) to avoid the possible overlaps between sub-pixels. Thanks to the invention, it is therefore no longer necessary to keep separating white lines between the sub-pixels in order to maintain a tolerance in the positioning of the sub-pixels, which allows increasing the maximum color saturation of each sub-pixel pixel (less white per pixel and therefore more fundamental colors).

However, white sub-pixels, possibly of reduced size, can be kept in the arrangement of pixels in order to achieve the desired level of brightness. It is even possible to remove the white sub-pixels because the hologram inherently has high brightness and particularly allows obtaining greater brightness than with printed inks. Thus, it is possible to keep only fundamental color sub-pixels in the arrangement of pixels, which allows obtaining increased color saturation capacity. It is for example possible to form the pixels from only 3 sub-pixels (according to a hexagonal pattern for example), which allows achieving a theoretical maximum color saturation of 33% for each fundamental color.

By implementing the principle of the invention, it is possible to easily detect fraud when the image has been falsified or illegally reproduced. Furthermore, this level of complexity and security of the image achieved thanks to the invention does not happen at the expense of the quality of the visual rendering of the image.

The color modulation means according to the principle of the invention can take various forms: (1) destroyed regions of the holographic structure, (2) masking means or (3) amplification means, as described previously. The color image IG according to the invention may however comprise any combination, or under combination, of at least two among the forms (1), (2) and (3) indicated above (for example (1) and (2), or even (1) and (3), or even (2) and (3)).

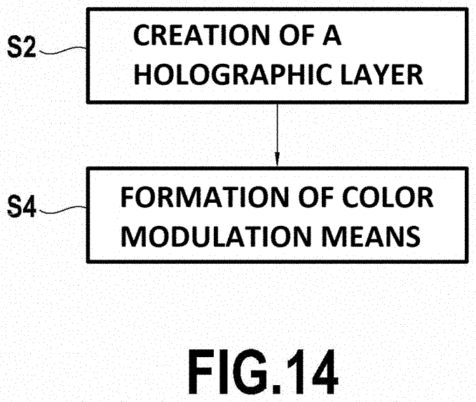

A method for manufacturing a color image IG as described above is now described with reference to FIG. 14, according to one particular embodiment. It is for example assumed that a color image IG is formed in a document 20 as illustrated in FIG. 3.

During a creation step S2, a holographic structure 27 which forms an arrangement 29 of pixels 30 as described previously is manufactured in a holographic layer 12. Each pixel 30 comprises a plurality of sub-pixels 32 of distinct colors according to one of the already described examples.

The layer 22 (FIG. 4) can be a thermoformable layer thus allowing the reliefs 24 of the holographic structure 27 to be formed by embossing on the layer 22 serving as a medium. As a variant, the reliefs 24 of the holographic structure 27 can be made using a UV crosslinking technique, as already indicated. As these manufacturing techniques are known to those skilled in the art, they are not described in more detail for the sake of simplicity.

A layer of adhesive and/or glue (not represented) can also be used to ensure adhesion of the holographic layer 12 on a medium (for example on a layer 42 or 42a already described above).

During a formation step S4, color modulation means 10 are formed as already described above, to select the color of the pixels 30 by modifying the relative colorimetric contribution of the sub-pixels 32 relative to each other in part at least of the pixels 30 so as to reveal a customized color image IG from the arrangement 29 of pixels combined with the color modulation means 10.

As already described, the thus formed color modulation means 10 may comprise at least one among:
regions (RG1) of the holographic structure, called destroyed regions, which are locally destroyed over all or part of the sub-pixels 32 by a single first laser radiation LS1 (FIG. 8);
masking means (50; 60-62) positioned facing the arrangement 29 of pixels to locally mask all or part of the sub-pixels 32 (FIGS. 10-11); and
amplification means (68; 70-72) positioned facing the arrangement 29 of pixels to locally amplify the brightness of all or part of the sub-pixels 32 (FIGS. 12-13).

Thus, the destroyed regions RG1 represented in FIG. 8 are formed by local destruction, by means of a single laser radiation LS1, by laser ablation of regions of the holographic structure to eliminate all or part of the sub-pixels in the arrangement of pixels.

The masking means 50 represented in FIG. 10 are formed by printing ink patterns facing the holographic layer 12 obtained in step S2, so as to locally mask all or part of the sub-pixels in the arrangement of pixels.

The lenticular array 68 represented in FIG. 12 is formed by surface deformation of a layer 42a by means of a single laser radiation LS3, this lenticular array being disposed facing the arrangement 29 of pixels so as to generate the customized color image by focusing (or divergence) of an incident light through the lenses on at least part of the sub-pixels of the arrangement of pixels. As a variant, a projection of transparent material is carried out by using a 3D printer head so as to form lenses on the surface of the transparent layer 42a.

The optical amplification device 74 represented in FIG. 13 is formed so as to comprise a transparent laserable layer 40 as well as a transparent separating layer 70 disposed between the holographic layer 12 and the transparent laserable layer 40. Opaque areas 72 are in further formed locally, by means of a single laser radiation LS4, by carbonization in the laserable layer 40 facing the holographic layer 12 so as to cause an amplification of the brightness of sub-pixels 32 in the arrangement 30 of pixels in regions corresponding to said opaque areas.

It is thus possible to form the color modulation means 10 using a single laser radiation, namely one of LS1, LS2, LS3 and LS4 depending on the type of color modulation means 10 desired to be formed. In other words, the color modulation means 10 can be formed using a single laser radiation among:
the laser radiation LS1 necessary to produce destroyed regions RG1 as already described (FIG. 8);
the laser radiation LS2 necessary to form opaque areas 62 as already described (FIG. 11);
the laser radiation LS3 necessary to form a lenticular array 68 as already described (FIG. 12); and
the laser radiation LS4 necessary to form opaque areas 72 as already described (FIG. 13).

According to one particular example, the color modulation means 10 can be formed using two distinct laser radiations at most, among the radiations LS1 and LS4 described above.

According to one particular example, the laser radiations LS2 and LS4 are identical.

The invention thus allows securely generating a high-quality customized color image, from a relatively uncomplicated manufacturing method.

Those skilled in the art will understand that the embodiments and variants described in this document constitute only non-limiting examples of implementation of the invention. Particularly, those skilled in the art may envisage any adaptation or combination among the characteristics and embodiments described above in order to meet a very particular need.

1-15. (canceled)

16. A secure document, comprising:
a first layer including a holographic structure forming an arrangement of pixels each including a plurality of sub-pixels of distinct colors; and
color modulation means configured to select the color of the pixels by modifying the colorimetric contribution of the sub-pixels relative to each other at least in part of the pixels so as to reveal a customized color image from the arrangement of pixels combined with said modulation means,
the color modulation means comprising at least one among:
regions of the holographic structure which are locally destroyed by laser;
masking means positioned facing the arrangement of pixels to locally mask all or part of the sub-pixels; and
amplification means positioned facing the arrangement of pixels to locally amplify the brightness of all or part of the sub-pixels.

17. The document according to claim 16, wherein each sub-pixel in the arrangement of pixels is formed by a respective holographic grating configured to generate by diffraction a corresponding color of said sub-pixel.

18. The document according to claim 16, wherein each pixel of said arrangement of pixels forms an identical pattern of color sub-pixels.

19. The document according to claim 16, wherein each pixel of said arrangement of pixels is configured such that each sub-pixel has a unique color in said pixel.

20. The document according to claim 16, wherein the arrangement of pixels is configured such that the sub-pixels are evenly distributed on or in a substrate.

21. The document according to claim 16, wherein the arrangement of pixels forms contiguous lines of sub-pixels.

22. The document according to claim 16, wherein said regions destroyed in the holographic structure correspond to areas destroyed by laser ablation of the holographic gratings corresponding to all or part of the sub-pixels in the arrangement of pixels.

23. The document according to claim 22, wherein said destroyed regions comprise sub-pixels whose corresponding holographic grating is partially destroyed by laser micro-ablation.

24. The document according to claim 16, wherein said masking means forming part of the color modulation means comprise at least one among:
ink patterns printed facing the arrangement of pixels to locally mask all or part of the sub-pixels; and
laser points of different grayscales formed in a second layer so as to be positioned facing the arrangement of pixels to locally mask all or part of the sub-pixels.

25. The document according to claim 16, wherein said amplification means forming part of the color modulation means comprise at least one among:
an array of lenses disposed facing the arrangement of pixels so as to generate the customized color image by focusing or diverging an incident light through the lenses on at least part of the sub-pixels; and
an optical amplification device comprising a transparent laserable third layer and a transparent separating layer disposed between the first layer and the third layer, said third layer comprising areas locally opacified with laser, facing the first layer so as to cause an amplification of the brightness of sub-pixels in said arrangement of pixels in regions corresponding to said opacified areas.

26. The document according to claim 25, wherein each lens of the array of lenses is positioned, relative to an associated pixel located oppositely, to focus or diverge an incident light on at least one of the sub-pixels of said associated pixel so as to modify the contribution of the respective colors of the sub-pixels of the associated pixel, in a region of the customized color image generated through said lens, relative to the pattern intrinsically formed by the associated pixel independently of said lens.

27. The document according to claim 16, wherein the document further comprises a transparent laserable fourth layer, facing the first layer, said fourth layer being at least partially carbonized by laser radiation so as to comprise locally opacified regions facing sub-pixels of the arrangement of pixels to produce grayscales in the customized color image.

28. The document according to claim 16, wherein the first layer comprises:
a first sub-layer of varnish forming the reliefs of a holographic grating; and
a second sub-layer deposited on the reliefs of the first sub-layer, said second sub-layer having a refractive index greater than that of the first sub-layer.

29. A method for manufacturing a document, comprising:
creating in a first layer a holographic structure forming an arrangement of pixels each including a plurality of sub-pixels of distinct colors;
forming color modulation means to select the color of the pixels by modifying the colorimetric contribution of the sub-pixels relative to each other at least in part of the pixels so as to reveal a customized color image from the arrangement of pixels combined with said color modulation means,
the color modulation means comprising at least one among:
regions of the holographic structure which are locally destroyed over all or part of the sub-pixels by a single first laser radiation;
masking means positioned facing the arrangement of pixels to locally mask all or part of the sub-pixels; and
amplification means positioned facing the arrangement of pixels to locally amplify the brightness of all or part of the sub-pixels.

30. The method according to claim 29, wherein said formation of the color modulation means comprises at least one among:
local destruction, by means of a single first laser radiation, by laser ablation, of regions of the holographic structure to eliminate all or parts of the sub-pixels in the arrangement of pixels;
printing ink patterns facing the first layer to locally mask all or part of the sub-pixels in the arrangement of pixels;
formation, by means of a single second laser radiation, of an array of lenses disposed facing the arrangement of pixels so as to generate the customized color image by focusing or diverging an incident light through the lenses on at least part of the sub-pixels of the arrangement of pixels; and
formation of an optical amplification device comprising a transparent laserable third layer and a transparent separating layer disposed between the first layer and the third layer, said third layer comprising areas locally opacified by means of a single third laser radiation, facing the first layer so as to cause an amplification of the brightness of sub-pixels in said arrangement of pixels in regions corresponding to said opacified areas.
